(19) United States
(12) Patent Application Publication
(10) Pub. No.: US 2008/0058162 A1
(43) Pub. Date: Mar. 6, 2008

(54) Method for operating a brake system of a motor vehicle

(76) Inventor: Mario Schmidt, IIsfeld-Auenstein (DE)

Correspondence Address: KENYON & KENYON LLP, ONE BROADWAY, NEW YORK, NY, 10004, US

(21) Appl. No.: 11/897,174

(22) Filed: Aug. 28, 2007

(30) Foreign Application Priority Data
Sep. 1, 2006 (DE) 102006041194.3

(51) Int. Cl. B60T 13/66; B60T 8/17

(52) U.S. Cl. 477/184; 303/121

(57) ABSTRACT

A method for operating a brake system of a motor vehicle, prefilling taking place to at least partially overcome an air gap of one wheel brake or a plurality of wheel brakes if the air gap of at least one wheel brake is increased, in particular as a result of dynamic influences of the vehicle motion.

### FIELD OF THE INVENTION

The present invention relates to a method, a device and a computer program for operating a brake system of a motor vehicle.

### BACKGROUND INFORMATION

The function of electronic prefilling of a service brake (electronic brake prefill EBP) overcomes the air gap of the wheel brake by applying the brake linings. Overcoming the air gap reduces the response time of the brake system in a subsequent actuation of the brake pedal. This leads to a shorter pressure-generation time, and thereby shortens the stopping distance.

From German Patent Application No. DE 10 2004 030464, for instance, a brake system having ELB (electronically controlled braking) and prefill function is known as well as a method for electronic brake control. To activate the ELB function in the related art, the accelerator pedal must be released very quickly, from which a possible emergency situation and subsequent panic braking are inferred. The air gap is overcome by an hydraulic control unit, which sets a slight wheel pressure for the application of the brake linings.

The response of the service brake in the related art is improved only if the driver releases the accelerator pedal rapidly. In contrast, in driving situations with an especially large air gap, for instance due to so-called knock-back, the response of the brake can be very poor. Knock-back means an increase in the air gap, for example due to the transverse acceleration of a motor vehicle. In such a case, the brake pistons are enlarged by a transverse acceleration to which they are subjected, or by an increase in the imbalance of the brake disk due to mechanical effects acting on the wheel axle during cornering, for example. The response of the brake may be very poor in such a situation, so that a fairly large air gap must be overcome and thus a long pedal travel before there is a sufficient response of the service brake.

### SUMMARY OF THE INVENTION

Therefore, an objective of the present invention is to improve the response of the service brake.

This problem is solved by a method for operating a brake system of a motor vehicle, in which prefilling takes place to at least partially overcome an air gap of one wheel brake or a plurality of wheel brakes if the air gap of at least one wheel brake is increased, in particular as a result of dynamic influences of the vehicle motion. The dynamic influences are, in particular, translatory or rotatory accelerations of the vehicle, but may also be, for example, deformations of the vehicle body, the axle geometries or individual components of the axles, such as the brake disks. By applying the brake linings through prefilling of the brake system, the present invention makes it possible to improve the response of the service brake and thereby shorten the stopping distance in the case of a larger air gap, especially as a consequence of so-called knock-back. The improved response also results in better pedal feel during braking.

According to the present invention, the prefilling activation takes place independently of the gradient of the accelerator pedal, and thus independently of a potential emergency situation. Knock-back increases the air gap of the brake. If the driver brakes in a vehicle without the method of the present invention, he must first overcome the air gap. This has a detrimental effect on the response of the brake and leads to a longer stopping distance. Furthermore, the larger air gap results in an unusually soft pedal feel during the initial braking. In the case of a very large brake and very large air gap, the driver may also notice excessive travel of the brake pedal. In contrast, if the air gap is overcome or reduced once a larger air gap has come about, then the response time of the brake is briefer, the stopping distance shortened, and the pedal feel improved.

Prefilling preferably takes place when a limit value of a transverse acceleration and/or a limit value of a steering angle and/or a limit value of a yaw rate have/has been exceeded. The prefilling may occur additionally or alternatively also when a measured limit value of the air gap was exceeded. Thus, an increased air gap may either be detected with the aid of measuring technology, or an increased air gap may be inferred on the basis of other measured physical operating parameters of the motor vehicle. An increased air gap may exist when the vehicle is cornering, for example. Cornering is able to be detected with the aid of a steering angle or the transverse acceleration, for instance. If the absolute value of the yaw rate exceeds a threshold value, then it is likewise possible to infer a larger air gap. The air gap may be removed as soon as an increased air gap has come about or as soon as the assumption has been made that such an increased air gap has come about, or else only later on, for instance when the driver releases the accelerator and it is likely that he intends to brake afterwards. Prefilling may occur at one axle or at both axles. Simultaneous or time-staggered prefilling of the axles is possible. The prefilling may be carried out after a time delay; the time delay may be a constant delay or depend on additional operating parameters of the motor vehicle.

This problem mentioned in the introduction is also solved by a device, in particular a control device, for operating a brake system of a motor vehicle, in which prefilling takes place to at least partially overcome an air gap of one wheel brake or a plurality of wheel brakes if the air gap of at least one wheel brake has become larger, in particular as a result of dynamic influences of the vehicle motion.

The objective indicated at the outset is also achieved by a computer program having program code for carrying out all steps of a method according to the present invention when the program is executed on a computer.

### BRIEF DESCRIPTION OF THE DRAWINGS

FIG. 1 shows a sketch of an hydraulic brake system.

FIG. 2 shows a flow chart of an exemplary embodiment of a method according to the present invention.

### DETAILED DESCRIPTION

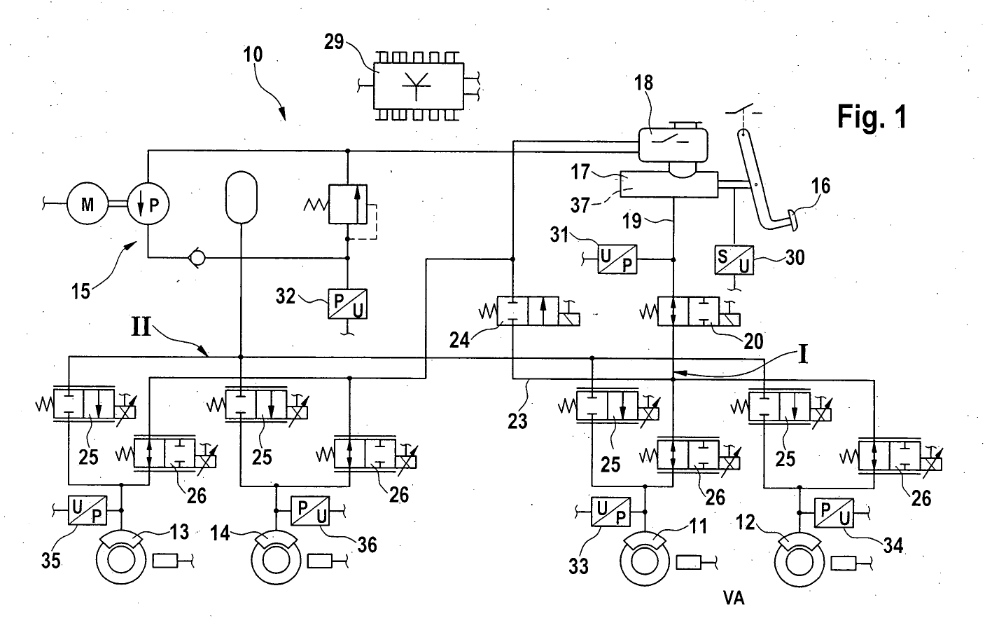

A power-assisted, hydraulic brake system (wheel brake system) 10 for passenger cars shown in FIG. 1 has a brake circuit I assigned to wheel brakes 11, 12 of front axle FA of the vehicle, and a brake circuit 11 assigned to wheel brakes 13, 14 of rear axle RA. A servo-pressure source 15, which supplies the energy required for the generation of braking force, is connected to both brake circuits I and II. Brake system 10 thus has a service brake, which is activated by external forces. Brake system 10 also includes a secondary brake, which is actuated by muscular energy. It has a main brake cylinder 17, which is actuable by a brake pedal 16 and includes a pressure-medium reservoir 18. Main brake cylinder 17 has a single-circuit design, i.e., it is connected to brake circuit I by a line 19 and a first valve 20 disposed therein. In the illustrated position of valve 20, the secondary brake therefore acts only on wheel brakes 11 and 12 of front axle FA. With an active service brake, valve 20 blocks the connection between the main brake cylinder and wheel brakes 11 and 12. First valve 20 assigned to main brake cylinder 17 is therefore denoted as shutoff valve in the following text.

Servo-pressure source 15 aspirates pressure medium from reservoir 18 of main brake cylinder 17 and pressurizes it to high pressure for the functionality of the service brake. Pressure medium withdrawn from wheel brakes 11 through 14 while the service brake is in action is returned to reservoir 18. To block brake circuit I with respect to pressure medium reservoir 18 when the secondary brake is active, a shutoff valve 24 is disposed in a line 23 leading to the pressure medium reservoir. In addition, two valves 25 and 26 for the modulation of the brake pressure in an active service brake are assigned to each wheel brake 11 through 14.

Brake system 10 is equipped with an electronic control device 29 to which, in addition to valves 20, 24, 25 and 26, a displacement sensor 30 is connected, which detects the displacement of brake pedal 16, as well as six pressure sensors 31 through 36 by which the pressure generated by main brake cylinder 17, the pressure supplied by servo-pressure source 15, and also the pressures applied into wheel brakes 11 through 14 are able to be detected. While the secondary brake operates hydraulically in the conventional manner, without involvement of control device 29, the service brake operates electro-hydraulically, i.e., if the driver of the passenger car actuates brake pedal 16, the electrical displacement signal detected by displacement sensor 30, and possibly additional electrical signals are evaluated by control device 29 for the control of control valves 20, 24, 25 and 26 in order to generate braking pressure inside wheel brakes 11 through 14 according to the requested brake torque, the brake pressure being monitored by the electronic control device with the aid of the electrical signals from pressure sensors 31, 33 through 36. In addition, the vehicle includes at least one acceleration sensor by which transverse acceleration A_{Q} is able to be determined, and, indirectly, yaw rate G as well. Furthermore, the steering angle of the vehicle is ascertainable via a sensor.

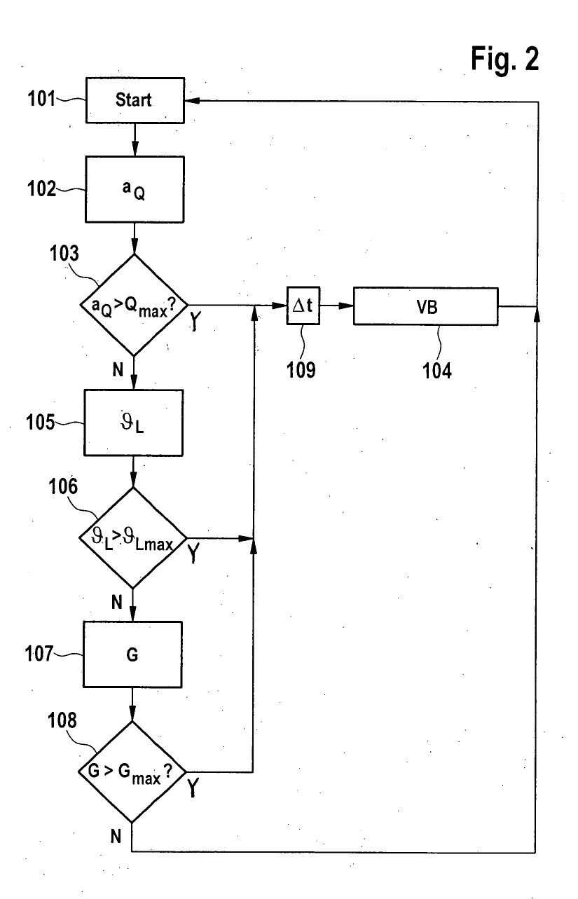

FIG. 2 shows a flow chart of an exemplary embodiment of a method according to the present invention. The method begins in step 101. In step 102, transverse acceleration A_{Q} of the vehicle is determined. This may be done with the aid of an acceleration sensor, for example, which emits an electrical signal that is a measure for the magnitude of the transverse acceleration. In step 103 it is checked whether transverse acceleration A_{Q} is greater than a maximum value A_{QMax} of the transverse acceleration. If this is the case—indicated by the Y option—then prefilling so as to at least partially overcome the air gap of one wheel brake or a plurality of wheel brakes takes place in step 104. Following successful prefilling in step 104, rebranching in the sense of a loop takes place to the starting point of the method in step 101. If the check in step 103 showed that transverse acceleration A_{Q} was smaller than the maximum value of transverse acceleration A_{QMax}—denoted by the N option—, then steering angle υ_{L} of the vehicle will be determined in step 105. The steering angle is the wheel angle of the front wheels relative to the straight-line rolling direction. In step 106, it is checked whether steering angle υ_{L} is greater than a maximally permissible steering angle υ_{LMax}. If this is the case—indicated by the Y option—, branching to step 104 takes place, and prefilling of the wheel brakes occurs as a result. If this is not the case—denoted by the N option—, then yaw rate G of the vehicle will be ascertained in step 107. The yaw rate in a vehicle denotes the rotation about the vertical axis. This may be determined, for instance, in the form of a maximum value of the rotational acceleration or a maximum value of the angular velocity of the rotation. In step 108, it will then be checked whether yaw rate G is greater than a maximally permissible yaw rate Gₘₐₓ. If this is the case—indicated by the Y option—, branching to step 104 will take place and prefilling of the brake system occurs. If this is not the case—denoted by the N option—, immediate branching to the starting point of the method, i.e., step 101, is implemented. A delay may be incorporated prior to step 104, which is marked by step 109 including a time delay At, so that the prefilling is activated at a delay Δt. As an alternative to the time delay, a delay tied to other conditions may be provided.

What is claimed is:

1. A method for operating a brake system of a motor vehicle, comprising:
performing a prefilling operation to at least partially overcome an air gap of at least one wheel brake if an air gap of at least one wheel brake is increased, as a result of dynamic influences of a vehicle motion.

2. The method according to claim 1, wherein the prefilling takes place when a limit value of a transverse acceleration was exceeded.

3. The method according to claim 1, wherein the prefilling takes place when a limit value of a steering angle was exceeded.

4. The method according to claim 1, wherein the prefilling takes place when a limit value of a yaw rate was exceeded.

5. The method according to claim 1, wherein the prefilling takes place when a limit value of the air gap was exceeded.

6. The method according to claim 1, wherein the prefilling occurs at one axle.

7. The method according to claim 1, wherein the prefilling occurs at both axles.

8. The method according to claim 1, wherein the prefilling occurs after a time delay.

9. A control device for operating a brake system of a motor vehicle, comprising:
an arrangement for performing a prefilling operation to at least partially overcome an air gap of at least one wheel brake if an air gap of at least one wheel brake is increased, as a result of dynamic influences of a vehicle motion.

10. A computer-readable medium containing a computer program which when executed by a processor performs the following method for operating a brake system of a motor vehicle:
performing a prefilling operation to at least partially overcome an air gap of at least one wheel brake if an air gap of at least one wheel brake is increased, as a result of dynamic influences of a vehicle motion.
